(19) United States
(12) Patent Application Publication
(10) Pub. No.: US 2025/0031220 A1
(43) Pub. Date: Jan. 23, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(73) Assignee: GUANGDONG OPPO MOBILE TELECOMMUNICATIONS CORP., LTD., Dongguan (CN)

(21) Appl. No.: 18/908,055

(22) Filed: Oct. 7, 2024

Related U.S. Application Data
(63) Continuation of application No. PCT/CN2022/101020, filed on Jun. 24, 2022.

(51) Int. Cl. H04W 72/231; H04L 1/1812; H04W 72/12; H04W 76/28; H04W 84/06

(52) U.S. Cl. CPC H04W 72/231; H04L 1/1812; H04W 72/12; H04W 76/28; H04W 84/06

(57) ABSTRACT

A wireless communication method, a terminal device, and a network device are disclosed. The method includes: receiving, by a terminal device, a first PDCCH, where the first PDCCH is used to schedule a first TB, and the first TB corresponds to a first HARQ process; and determining, by the terminal device, DRX behavior of the terminal device based on a mode corresponding to the first HARQ process, where the mode corresponding to the first HARQ process includes a first mode and a second mode, and the first mode corresponds to DRX behavior different from the second mode. In this application, considering that DRX behavior varies with different modes of a HARQ process, the DRX behavior is determined based on the specific mode corresponding to the HARQ process, so that a PDCCH can be monitored at a proper occasion.

### CROSS-REFERENCE TO RELATED APPLICATIONS

This application is a continuation of International Application No. PCT/CN2022/101020, filed on Jun. 24, 2022, the disclosure of which is hereby incorporated by reference in its entirety.

### TECHNICAL FIELD

This application relates to the technical field of communications, and more specifically, to a wireless communication method, a terminal device, and a network device.

### BACKGROUND

In a case that a discontinuous reception (DRX) function is configured for a terminal device, the terminal device can monitor a physical downlink control channel (PDCCH) discontinuously, so as to save power of the terminal device.

In some communications systems, a mode of a hybrid automatic repeat request (HARQ) process may include a first mode and a second mode. Taking a downlink HARQ process as an example, HARQ feedback may be performed in the HARQ process in the first mode, and HARQ feedback may not be performed in the HARQ process in the second mode.

### SUMMARY

This application provides a wireless communication method, a terminal device, and a network device. Various aspects of this application are described below.

According to a first aspect, a wireless communication method is provided, including: receiving, by a terminal device, a first PDCCH, where the first PDCCH is used to schedule a first transport block TB, and the first TB corresponds to a first HARQ process; and determining, by the terminal device, DRX behavior of the terminal device based on a mode corresponding to the first HARQ process, where the mode corresponding to the first HARQ process includes a first mode and a second mode, and the first mode corresponds to DRX behavior different from the second mode.

According to a second aspect, a wireless communication method is provided, including: sending, by a network device, a first PDCCH, where the first PDCCH is used to schedule a first TB, and the first TB corresponds to a first HARQ process, where a mode corresponding to the first HARQ process is used to determine DRX behavior of a terminal device, the mode corresponding to the first HARQ process includes a first mode and a second mode, and the first mode corresponds to DRX behavior different from the second mode.

According to a third aspect, a terminal device is provided, including: a first receiving unit, configured to receive a first PDCCH, where the first PDCCH is used to schedule a first TB, and the first TB corresponds to a first HARQ process; and a first determining unit, configured to determine DRX behavior of the terminal device based on a mode corresponding to the first HARQ process, where the mode corresponding to the first HARQ process includes a first mode and a second mode, and the first mode corresponds to DRX behavior different from the second mode.

According to a fourth aspect, a network device is provided, including: a first sending unit, configured to send a first PDCCH, where the first PDCCH is used to schedule a first TB, and the first TB corresponds to a first HARQ process, where a mode corresponding to the first HARQ process is used to determine DRX behavior of a terminal device, the mode corresponding to the first HARQ process includes a first mode and a second mode, and the first mode corresponds to DRX behavior different from the second mode.

According to a fifth aspect, a terminal is provided, including a processor, a memory, and a communications interface. The memory is configured to store one or more computer programs, and the processor is configured to invoke the computer program in the memory, to cause the terminal device to execute some or all of the steps in the method according to the first aspect.

According to a sixth aspect, a network device is provided, including a processor, a memory, and a communications interface. The memory is configured to store one or more computer programs, and the processor is configured to invoke the computer program in the memory, to cause the network device to execute some or all of the steps in the method according to the second aspect.

According to a seventh aspect, an embodiment of this application provides a communications system, and the system includes the foregoing terminal and/or the foregoing network device. In another possible design, the system may further include another device interacting with the terminal or the network device in the solutions provided in embodiments of this application.

According to an eighth aspect, an embodiment of this application provides a computer-readable storage medium. The computer-readable storage medium stores a computer program, and the computer program causes a terminal to execute some or all of the steps in the method according to the foregoing aspects.

According to a ninth aspect, an embodiment of this application provides a computer program product. The computer program product includes a non-transitory computer-readable storage medium that stores a computer program, and the computer program is operable to cause a terminal to execute some or all of the steps in the method according to the foregoing aspects. In some implementations, the computer program product may be a software installation package.

According to a tenth aspect, an embodiment of this application provides a chip. The chip includes a memory and a processor, and the processor may invoke and run a computer program in the memory, to implement some or all of the steps of the method according to the foregoing aspects.

In this application, considering that DRX behavior varies with different modes of a HARQ process, the DRX behavior is determined based on the specific mode corresponding to the HARQ process, so that a PDCCH can be monitored at a proper occasion. Therefore, in the different modes of the HARQ process, better scheduling performance can be achieved while saving power of the terminal device.

### BRIEF DESCRIPTION OF DRAWINGS

FIG. 1 shows a wireless communications system to which embodiments of this application are applied.

FIG. 2 is a schematic diagram of a transparent payload network architecture.

FIG. 3 is a schematic diagram of a regenerative payload network architecture.

FIG. 4 is a schematic diagram of a running process of a DRX on duration timer.

FIG. 5 is a schematic flowchart of a wireless communication method according to an embodiment of this application.

FIG. 6 is a schematic diagram of a method for starting a first timer according to an embodiment of this application.

FIG. 7 is a schematic diagram of another method for starting a first timer according to an embodiment of this application.

FIG. 8 is a schematic diagram of a communication method including step S621 according to an embodiment of this application.

FIG. 9 is a schematic diagram of a communication method including step S622 according to an embodiment of this application.

FIG. 10 is a schematic diagram of a communication method including step S721 according to an embodiment of this application.

FIG. 11 is a schematic diagram of a communication method including step S722 according to an embodiment of this application.

FIG. 12 is a schematic diagram of a feedback time sequence in which a first PDCCH schedules a plurality of downlink TBs according to an embodiment of this application.

FIG. 13 is a schematic structural diagram of a terminal device according to an embodiment of this application.

FIG. 14 is a schematic structural diagram of a network device according to an embodiment of this application.

FIG. 15 is a schematic structural diagram of a communications apparatus according to an embodiment of this application.

### DESCRIPTION OF EMBODIMENTS

The technical solutions in this application are described below with reference to the accompanying drawings.

### Communications System

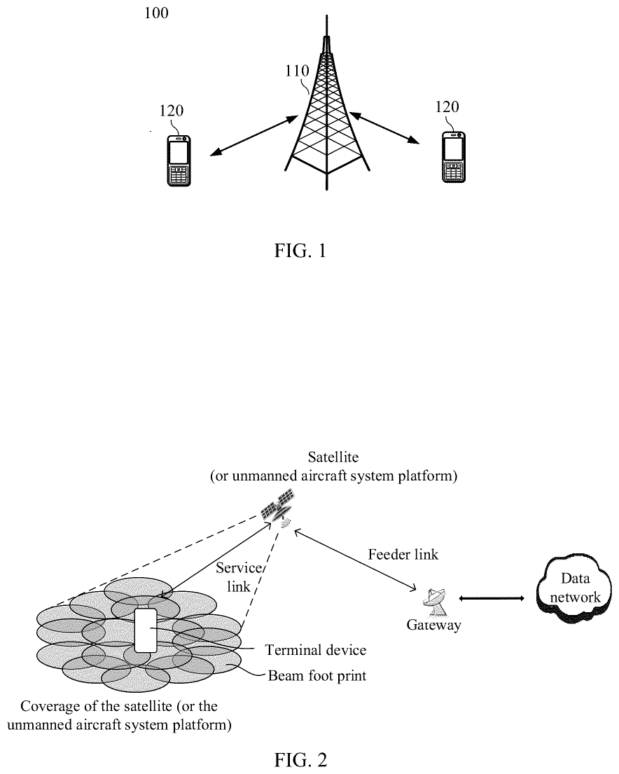

FIG. 1 shows a wireless communications system 100 to which embodiments of this application are applied. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 exemplarily shows one network device and two terminals. Optionally, the wireless communications system 100 may include a plurality of network devices, and another quantity of terminal devices may be included within coverage of each network device, which is not limited in embodiments of this application.

Optionally, the wireless communications system 100 may further include another network entity such as a network controller or a mobility management entity, which is not limited in embodiments of this application.

It should be understood that the technical solutions in embodiments of this application may be applied to various communications systems, such as a 5th generation (5G) system or new radio (NR), a long term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or an in-vehicle device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, UE may be used to function as a base station. For example, the UE may function as a scheduling entity, which provides a sidelink signal between UE in V2X, D2D, or the like. For example, a cellular phone and a vehicle communicate with each other through a sidelink signal. However, a cellular phone and a smart household device communicate with each other without relaying a communication signal by a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a radio network. The base station may broadly cover the following various names, or replace with the following names, for example: a NodeB, an evolved NodeB (eNB), a next generation NodeB (gNB), a relay station, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device to device D2D, vehicle-to-everything (V2X), and machine-to-machine (M2M) communication, a network side device in a 6G network, a device that functions as a base station in a future communications system, or the like. The base station may support networks of a same access technology or different access technologies. A specific technology and a specific device form used by the network device are not limited in embodiments of this application.

The base station may be stationary or mobile. For example, a helicopter or an unmanned aircraft may be configured to function as a mobile base station, and one or more cells may move depending on a location of the mobile base station. In another example, a helicopter or an unmanned aircraft may be configured to function as a device in communication with another base station.

In some deployments, the network device in embodiments of this application may be a CU or a DU, or the network device includes a CU and a DU. A gNB may further include an AAU.

The network device and the terminal device may be deployed on land, including being indoors or outdoors, handheld, or in-vehicle, may be deployed on a water surface, or may be deployed on a plane, a balloon, or a satellite in the air. In embodiments of this application, a scenario in which the network device and the terminal device are located is not limited.

It should be understood that all or a part of functions of the communications device in this application may also be implemented by software functions running on hardware, or by virtualization functions instantiated on a platform (for example, a cloud platform).

### Non-Terrestrial Network (NTN)

An NTN provides a user with a communication service in a non-terrestrial manner. The non-terrestrial manner may include, for example, a satellite or an unmanned aircraft system platform (UAS platform).

For terrestrial network communication, in a scenario such as a sea, a mountain, or a desert, a communications device cannot be set up for land communication. Alternatively, considering construction and operation costs of the communications device, land communication generally does not cover a sparsely populated area. The NTN has many advantages over terrestrial network (TN) communication. First, NTN communication may not be limited by a user area. The NTN communications network is not limited by an area. In theory, a satellite may orbit the earth, so every corner of the earth may be covered by satellite communication. In addition, an area that may be covered by an NTN communications device is far larger than an area covered by a terrestrial communications device. For example, in satellite communication, a satellite may cover a relatively large terrestrial area. Second, NTN communication has a great social value. NTN communication may implement coverage at low costs, for example, may cover remote mountains or poor and backward countries or regions at low costs through satellite communication. This enables people in these regions to enjoy advanced voice communication and mobile internet technologies, which helps narrow a digital divide with developed regions and promote development of these regions. Third, a communication distance of NTN communication is long, and communication costs are not significantly increased. In addition, NTN communication has high stability. For example, NTN communication may not be limited by a natural condition, and may be used even in a case of a natural disaster.

### Communications Satellite

According to orbital altitude, communications satellites may be classified into a low-earth orbit (LEO) satellite, a medium-earth orbit (MEO) satellite, a geostationary earth orbit (GEO) satellite, a high elliptical orbit (HEO) satellite, and the like. The following describes the LEO satellite and the GEO satellite in detail.

An orbital altitude of the LEO satellite ranges from 500 km to 1500 km. An orbital period is about 1.5 hours to 2 hours. A signal propagation delay of single-hop communication between users is generally less than 20 ms. A maximum satellite visible time is 20 minutes. A signal propagation distance is short, a link loss is small, and a transmit power requirement for a user terminal is not high.

An orbital altitude of the GEO satellite may be 35,786 km. A rotation period of the GEO satellite around the earth is 24 hours. A signal propagation delay of single-hop communication between users is generally 250 ms.

To ensure coverage of a satellite and improve a system capacity of an entire satellite communications system, the satellite may use a plurality of beams to cover the ground, that is, a plurality of beam foot prints may form a field of view of the satellite. For example, one satellite may form dozens or even hundreds of beams to cover the ground. One satellite beam may cover a terrestrial area of tens to hundreds of kilometers in diameter.

### Satellite Network Architecture

An NTN network may be implemented based on a satellite network architecture. The satellite network architecture may include the following network elements: a gateway, a feeder link, a service link, a satellite, an inter-satellite link (ISL), and the like.

There may be one or more gateways. The gateway may be configured to connect the satellite to a terrestrial public network. The gateway is usually located on the ground.

The feeder link may be a link for communication between the gateway and the satellite.

The service link may be a link for communication between a terminal device and the satellite.

The satellite network architecture may be classified into a transparent payload network architecture and a regenerative payload network architecture in terms of provided functions.

FIG. 2 is a schematic diagram of a transparent payload network architecture. The transparent payload network architecture may provide radio frequency filtering, frequency conversion, and amplification functions. The transparent payload network architecture only forwards of a signal, and does not change a waveform signal forwarded by the transparent payload network architecture.

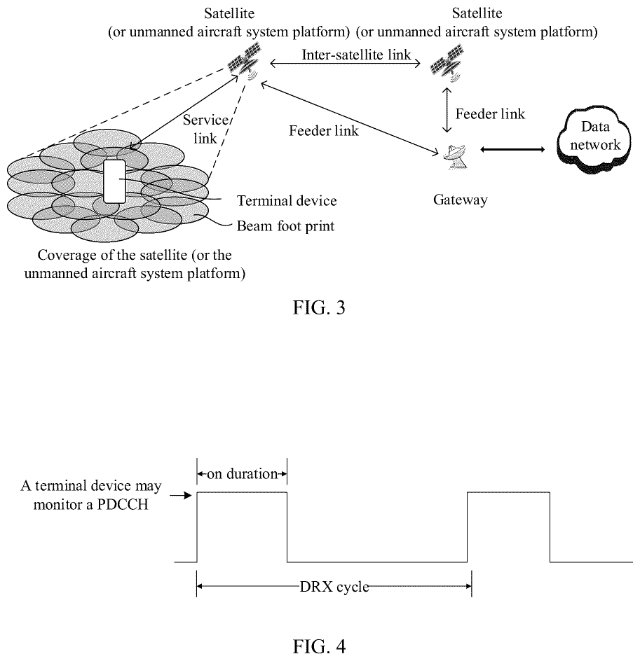

FIG. 3 is a schematic diagram of a regenerative payload network architecture. The regenerative payload network architecture may provide radio frequency filtering, frequency conversion, and amplification functions, and may further provide demodulation/decoding, routing/conversion, and coding/modulation functions. In the regenerative payload network architecture, a satellite may have some or all of functions of a base station. The inter-satellite link may exist in the regenerative payload network architecture.

### Discontinuous Reception (DRX)

In some communications systems (for example, an LTE system), a network device may configure a DRX function for a terminal device. In a case that the DRX function is configured for the terminal device, the terminal may monitor a PDCCH discontinuously, so as to save power of the terminal device.

Each medium access control (MAC) entity may have one DRX configuration. A DRX configuration parameter includes one or more of the following: a DRX cycle, a DRX on duration timer (drx-onDurationTimer), a delay of starting the DRX on duration timer by the terminal device (drx-StartOffset), a DRX inactivity timer (drx-InactivityTimer), a DRX retransmission timer (drx-RetransmissionTimer), and a DRX uplink retransmission timer (drx-ULRetransmissionTimer). It should be noted that, in some embodiments, the DRX retransmission timer may be a DRX downlink retransmission timer (drx-RetransmissionTimerDL).

If the DRX is configured for the terminal device, the terminal needs to monitor a PDCCH in a DRX active period, and the terminal may not monitor a PDCCH in a DRX inactive period. The DRX active period may include, for example, the following five cases.
Case 1: One or more of the following timers are running: a DRX on duration timer (drx-onDurationTimer), a DRX inactivity timer (drx-InactivityTimer), a DRX downlink retransmission timer (drx-RetransmissionTimerDL), a DRX short TTI retransmission timer (drx-Retransmission TimerShortTTI), a DRX uplink retransmission timer (drx-RetransmissionTimerUL), a DRX short TTI uplink retransmission timer (drx-ULRetransmission TimerShortTTI), and a contention resolution timer (mac-ContentionResolutionTimer).
Case 2: A scheduling request (SR) is transmitted on a physical uplink control channel (PUCCH) or a short physical uplink control channel (SPUCCH) and is in a pending state.
Case 3: In a non-contention-based random access process, after successfully receiving a random access response, the terminal device has not received initial transmission indicated by a physical downlink control channel (PDCCH) scrambled by a cell radio network temporary identifier (C-RNTI).
Case 4: For retransmission of one pending HARQ, an uplink scheduling grant (UL grant) may be received, and a HARQ buffer (HARQ buffer) of a synchronous HARQ process includes data.
Case 5: The terminal device is configured with mpdcch-UL-HARQ-ACK-FeedbackConfig and is currently performing retransmission within a bundle.

The following describes the DRX-related timers in detail.

### DRX on Duration Timer

In a process of running the DRX on duration timer, the terminal device may monitor a PDCCH. FIG. 4 is an example diagram of a running process of a DRX on duration timer. As shown in FIG. 4, when the DRX on duration timer is running within a DRX cycle, that is, an on duration shown in FIG. 4, the terminal device may monitor a PDCCH.

The DRX cycle may include a short DRX cycle or a long DRX cycle. The terminal may determine, based on whether the terminal is currently in a short DRX cycle or a long DRX cycle, a time for starting the DRX on duration timer.

The DRX on duration timer may be started at a time when the following conditions are met.

If the short DRX cycle is used and a current subframe SFN satisfies [(SFN×10)+subframe number] modulo (drx-ShortCycle)=(drxStartOffset) modulo (drx-ShortCycle), the DRX on duration timer may be started.

If the long DRX cycle is used and a current subframe SFN satisfies [(SFN×10)+subframe number] modulo (drx-LongCycle)=drx-StartOffset, it may be determined, based on a type of the terminal, whether to start the DRX on duration timer in the current subframe. For example, if the terminal device is a narrowband internet of things (NB-IoT) terminal device and an uplink HARQ round-trip time timer (RTT Timer) or a downlink RTT timer corresponding to at least one HARQ process is not running, the DRX on duration timer is started in the current subframe; or if the terminal device is not an NB-IoT device, the DRX on duration timer is started in the current subframe.

### DRX Deactivation Timer and DRX Retransmission Timer

When receiving a PDCCH for scheduling initial data transmission, the terminal may start a DRX deactivation timer. As described above, in a process of running the DRX deactivation timer, the terminal monitors a PDCCH. It may be understood that, based on the DRX deactivation timer, the terminal device may continuously monitor the PDCCH in a case that there is data to be newly transmitted.

When receiving a PDCCH for scheduling data transmission, the terminal may start a DRX retransmission timer after a period of time. Each HARQ process may correspond to one HARQ retransmission timer. As described above, in a process of running the DRX retransmission timer, the terminal monitors a PDCCH. It may be understood that, based on the DRX retransmission timer, the terminal device may monitor a PDCCH used for retransmission.

A start time of the DRX deactivation timer and/or the DRX retransmission timer may be related to a HARQ round-trip time (RTT) timer.

In some embodiments, for a DRX downlink retransmission timer, if the HARQ RTT timer expires and data decoding of the downlink HARQ process fails, the terminal device may start a DRX retransmission timer corresponding to the downlink HARQ process.

In some embodiments, for a DRX uplink retransmission timer, if an uplink HARQ RTT timer corresponding to an uplink HARQ process expires, the terminal may start a DRX uplink retransmission timer corresponding to the uplink HARQ process.

In some embodiments, for a DRX deactivation timer, if the HARQ RTT timer expires, it may be determined, based on a type of a terminal, whether to start a DRX inactivity timer. If the terminal device is an NB-IoT terminal device and a PDCCH indicates to schedule a plurality of transport blocks (TB), the DRX inactivity timer may be started when HARQ RTT timers corresponding to HARQ processes used by all these TBs expire. If the terminal device is an NB-IoT terminal device and a PDCCH indicates to schedule one TB, the DRX inactivity timer may be started when a HARQ RTT timer corresponding to a HARQ process used by this TB expires.

In some embodiments, for a DRX deactivation timer, and for an NB-IoT terminal device, if a PDCCH indicates to schedule a plurality of TBs, the DRX deactivation timer is started or restarted when uplink HARQ RTT timers corresponding to HARQ processes used by all these TBs expire. For an NB-IoT terminal device, if a PDCCH indicates to schedule one TB, the DRX deactivation timer is started or restarted when an uplink HARQ RTT timer corresponding to a HARQ process used by this TB expires. The following uses some examples to describe in detail how to determine a start time of a HARQ RTT timer and duration of the timer.

For starting of a downlink HARQ RTT timer, in some embodiments, a condition for starting the downlink HARQ RTT timer by the terminal device may include: if the terminal receives a PDCCH indicating downlink transmission or if the terminal has a configured downlink grant in the subframe, it may be determined, based on a type of the terminal, to start the HARQ RTT timer in the corresponding subframe. In a case that the terminal device is an NB-IoT terminal device or an enhanced machine type communication (eMTC) terminal device, if the PDCCH indicates to schedule transmission on a plurality of TBs, the terminal may start, in a subframe in which the last retransmission of a physical downlink shared channel (PDSCH) of the last TB in the plurality of TBs is received, HARQ RTT timers corresponding to all downlink HARQ processes used by PDSCHs of the plurality of TBs. In a case that the terminal device is an NB-IoT terminal device or an eMTC terminal device, if the PDCCH indicates to schedule transmission on a single TB, the terminal device may start, in a subframe in which the last retransmission of the PDSCH is received, a HARQ RTT timer corresponding to a downlink HARQ process used by the PDSCH. In a case that the terminal device is not an NB-IoT terminal device or an eMTC terminal device, a HARQ RTT timer corresponding to a downlink HARQ process used by the PDSCH is started in the corresponding subframe.

For starting of an uplink HARQ RTT timer, in some embodiments, a condition for starting the uplink HARQ RTT timer by the terminal device may include: if the terminal device receives a PDCCH indicating uplink transmission using an asynchronous HARQ process, or if the terminal device has a configured uplink grant for an asynchronous HARQ process in the subframe, or the terminal receives a PDCCH indicating uplink transmission using an automatic HARQ process, it may be determined, based on whether mpdcch-UL-HARQ-ACK-FeedbackConfig is configured, whether to start the uplink HARQ RTT timer in the subframe. If mpdcch-UL-HARQ-ACK-FeedbackConfig is not configured, in a case that the PDCCH indicates to schedule transmission on a plurality of TBs, the terminal device may start, in a subframe in which the last retransmission of a physical uplink shared channel (PUSCH) of the last TB in the plurality of TBs is completed, uplink HARQ RTT timers corresponding to all uplink HARQ processes used by PUSCHs of the plurality of TBs. If mpdcch-UL-HARQ-ACK-FeedbackConfig is not configured, in a case that the PDCCH indicates to schedule transmission on a single TB, the terminal device may start, in a subframe in which the last retransmission of the PUSCH is completed, an uplink HARQ RTT timer corresponding to an uplink HARQ process used by the PUSCH.

In some communications standards (for example, the R16 standard), definitions of the HARQ RTT timer and the uplink HARQ RTT timer may be described below.

For eMTC, if a PDCCH indicates to schedule one TB, the HARQ RTT timer is 7+N, where N is a PUCCH repetition factor used. For time division duplex (TDD), duration of the HARQ RTT timer may be 3+k+N, where k is a time interval between the last retransmission of a PDSCH and the first retransmission of a corresponding HARQ feedback, and N is a PUCCH repetition factor used.

For eMTC, if a PDCCH indicates to schedule a plurality of TBs and HACK-ACK bundling is not configured, the HARQ RTT timer is 7+m*N, where N is a PUCCH repetition factor used, and m is a quantity of scheduled TBs indicated by the PDCCH.

For eMTC, if a PDCCH indicates to schedule a plurality of TBs and HACK-ACK bundling is configured, the HARQ RTT timer is 7+k*N, where N is a PUCCH repetition factor used, and k is a quantity of times of HARQ feedback bundling and may satisfy k=ceiling (N_{TB}/M). N_{TB} is a quantity of scheduled TBs indicated by the PDCCH, and M is a HARQ feedback bundling size of multi-TB scheduling indicated by the PDCCH.

For NB-IoT, if a PDCCH indicates to schedule one TB, or if a PDCCH indicates to schedule a plurality of TBs at the same time and HARQ-ACK bundling is configured, the HARQ RTT timer is k+3+N+deltaPDCCH (unit may be a subframe), where k is a time interval between the last subframe for PDSCH transmission and the 1^{st} subframe for transmission of a corresponding HARQ feedback, N is transmission duration of the corresponding HARQ feedback, and deltaPDCCH is a time interval between the start of a subframe next to the last subframe for the corresponding HARQ feedback plus 3 subframes and the 1^{st} subframe corresponding to an occasion of a next PDCCH.

For NB-IoT, if a PDCCH indicates to schedule a plurality of TBs at the same time and HARQ-ACK bundling is not configured, the HARQ RTT timer is k+2*N+1+deltaPDCCH (unit may be a subframe), where k is a time interval between the last subframe for PDSCH transmission and the 1^{st} subframe for transmission of a corresponding HARQ feedback, N is transmission duration of the corresponding HARQ feedback, and deltaPDCCH is a time interval between the start of a subframe next to the last subframe for the corresponding HARQ feedback plus 1 subframe and the 1^{st} subframe corresponding to an occasion of a next PDCCH.

For eMTC, for frequency division duplex (FDD) and a frame structure type 3, the uplink HARQ RTT timer is four subframes. For TDD, the uplink HARQ RTT timer is K_{ULHARQRTT} subframes, where k_{ULHARQRTT} may be k_{PHICH}.

For NB-IoT, if a PDCCH indicates to schedule one TB, the uplink HARQ RTT timer is 4+deltaPDCCH subframes, where deltaPDCCH is a time interval between the start of a subframe next to the last subframe for PUSCH transmission plus 3 subframes and the 1^{st} subframe corresponding to an occasion of a next PDCCH.

For NB-IoT, if a PDCCH indicates to schedule a plurality of TBs at the same time, the uplink HARQ RTT timer is 1+deltaPDCCH subframes, where deltaPDCCH is a time interval between the start of a subframe next to the last subframe for PUSCH transmission plus 1 subframe and the 1^{st} subframe corresponding to an occasion of a next PDCCH.

For the NTN system, a signal transmission delay between the terminal and the network device greatly increases. Therefore, some communications protocols (for example, the R17 IoT NTN project) specify that an RTT offset is added to the definition formulas of the HARQ RTT timer and the uplink HARQ RTT timer. In a terrestrial network (TN) system, the RTT offset is 0, and in the NTN system, the RTT offset is an RTT (for example, UE-eNB RTT) between the terminal and a base station.

In some communications systems (for example, an R18 IoT NTN communications system), a mode of a HARQ process may include a first mode and a second mode. Taking a downlink HARQ process as an example, HARQ feedback may be performed by a terminal that performs PDSCH reception using the HARQ process in the first mode, and HARQ feedback may not be performed by a terminal that performs PDSCH reception using the HARQ process in the second mode.

As described above, a HARQ may affect DRX behavior. For example, the HARQ may affect a start time of a DRX deactivation timer and/or a start time of a DRX retransmission timer. This application provides a communication method to consider impact of a HARQ process on DRX behavior in different modes.

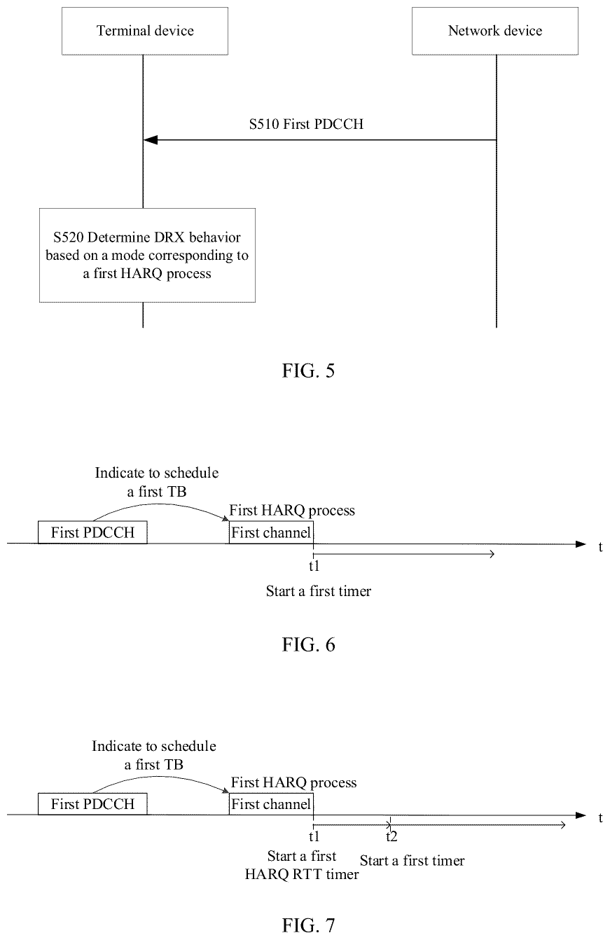

FIG. 5 is a schematic flowchart of a wireless communication method according to an embodiment of this application. The method shown in FIG. 5 may be executed by a terminal device and/or a network device. The network device may be a non-terrestrial network device, such as a satellite or an unmanned aircraft system platform. A serving cell of the terminal device may be an NTN cell.

The method shown in FIG. 5 may include step S510 and step S520.

Step S510: The terminal device receives a first PDCCH. Correspondingly, the network device sends the first PDCCH.

The first PDCCH may be used to schedule a first TB. It may be understood that the first PDCCH may be used to schedule a single TB, or may be used to schedule a plurality of TBs. In a case that the first PDCCH schedules a single TB, the first TB may be the TB scheduled by the first PDCCH. In a case that the first PDCCH schedules a plurality of TBs, the first TB may be any one of the plurality of TBs.

The first TB may be an uplink TB, or may be a downlink TB. In a case that the first PDCCH schedules uplink data, the first TB may be an uplink TB. In a case that the first PDCCH schedules downlink data, the first TB may be a downlink TB.

The first TB may correspond to a first HARQ process. The first HARQ process may be an uplink HARQ process, or may be a downlink HARQ process. In a case that the first TB is an uplink TB, the first HARQ process may be an uplink HARQ process. In a case that the first TB is a downlink TB, the first HARQ process may be a downlink HARQ process.

Step S520: The terminal device determines DRX behavior of the terminal device based on a mode corresponding to the first HARQ process.

The mode corresponding to the first HARQ process may include a first mode and a second mode. The first mode may correspond to DRX behavior different from the second mode.

In some embodiments, the first mode may be an enable HARQ feedback mode (or referred to as an enable mode), and the second mode may be a disable HARQ feedback mode (or referred to as a disable mode). It may be understood that, when the first HARQ is configured to be in the enable HARQ feedback mode, normal HARQ feedback may be performed on data transmission using the first HARQ, and when the first HARQ is configured to be in the disable mode, HARQ feedback may not be performed on data transmission using the first HARQ process.

In some embodiments, for an uplink HARQ process, the first mode may be a mode supported by the related art. In a case that a HARQ process is in the second mode, DRX behavior may be different from DRX behavior in the first mode.

It may be understood that, in this application, considering that DRX behavior varies with different modes of a HARQ process, the DRX behavior is determined based on the specific mode corresponding to the HARQ process, so that the terminal can monitor a PDCCH at a proper occasion. Therefore, in the different modes, better scheduling performance can be achieved while saving power of the terminal.

The DRX behavior may be behavior of the terminal device related to a DRX active period. For example, the DRX behavior may include a start time of a first timer. In a process of running the first timer, the terminal monitors a PDCCH. The first timer may include, for example, a DRX deactivation timer and/or a DRX retransmission timer. The DRX retransmission timer may correspond to the first HARQ process. The first timer may include an uplink timer and/or a downlink timer. In an example in which the first timer includes a DRX retransmission timer, the DRX retransmission timer may include a DRX uplink retransmission timer and/or a DRX downlink retransmission timer. In some embodiments, the DRX downlink retransmission timer is also referred to as a DRX retransmission timer.

It should be noted that starting of the first timer may include starting or restarting of the first timer. In other words, the starting of the first timer may include: newly creating a first timer and enabling the first timer to start running; or in a case that the first timer is running, restarting the first timer based on timing duration of the first timer.

In a case that the first HARQ process is in the second mode and the DRX behavior includes the start time of the first timer, the start time of the first timer may be determined based on first information. The first information may include one or more of the following: a transmission time of a first channel, or timing duration of a first HARQ RTT timer.

The first HARQ RTT timer may correspond to the first HARQ process. The first HARQ RTT timer may be a HARQ RTT timer corresponding to an uplink HARQ process or a downlink HARQ process, which is not limited in this application.

The first channel may carry the first TB, and the first channel may be, for example, a PDSCH or a PUSCH. When the first PDCCH schedules uplink data, the first channel may be a PUSCH. When the first PDCCH schedules downlink data, the first channel may be a PDSCH.

In some embodiments, the first information may include the transmission time of the first channel. The first timer may be started at a transmission end time of the first channel. For example, the first timer may be started immediately after the terminal device completes transmission on the first channel.

FIG. 6 is an example diagram of a method for starting a first timer according to an embodiment of this application. As shown in FIG. 6, the transmission end time of the first channel is t1. At the moment t1, the first timer may be started.

It may be understood that, in a case that the first HARQ process is in the second mode, the terminal device may ignore impact of a HARQ RTT timer corresponding to the first HARQ process on the DRX behavior. In other words, a time of starting the first timer may be independent of the HARQ RTT timer corresponding to the first HARQ process.

The transmission end time of the first channel may be the last time domain unit in a time domain resource occupied by the first channel or a time domain unit next to the last time domain unit in a time domain resource occupied by the first channel.

It should be noted that the time domain unit in this application may be any one of the following: a subframe, a slot, or one or more symbols. For example, the transmission end time of the first channel may be the last subframe in the time domain resource occupied by the first channel or a subframe next to the last subframe.

Retransmission (repetition) may be performed on the first channel. In this case, the transmission end time of the first channel may be a transmission end time of the last retransmission of the first channel.

The first PDCCH may schedule a plurality of TBs. The plurality of TBs may include the first TB. In this case, the transmission end time of the first channel may be a transmission end time of the last TB in the plurality of TBs. Modes of HARQ processes corresponding to the plurality of TBs may all be the second mode, and the second mode may be, for example, a disable mode. A part of the modes of the HARQ processes corresponding to the plurality of TBs may be the first mode and the other part may be the second mode, and the second mode may be, for example, a disable mode.

In an example in which the first channel is a PDSCH and the first PDCCH schedules a single TB, a transmission end time of the PDSCH may be a subframe in which the last retransmission of the PDSCH is located; or a transmission end time of the PDSCH may be a subframe next to a subframe in which the last retransmission of the PDSCH is located.

In an example in which the first channel is a PUSCH and the first PDCCH schedules a single TB, a transmission end time of the PUSCH may be a first subframe in which the last retransmission of the PUSCH is located; or a transmission end time of the PUSCH may be a subframe next to a first subframe. The first subframe may be the last subframe in which the last retransmission of the PUSCH is located.

In an example in which the first channel is a PDSCH and the first PDCCH schedules a plurality of TBs, a transmission end time of the PDSCH may be a second subframe in which the last retransmission of a PDSCH of the last TB in the plurality of TBs is located, or a transmission end time of the PDSCH may be a subframe next to a second subframe. The second subframe may be the last subframe in which the last retransmission of the PDSCH of the last TB in the plurality of TBs is located.

In an example in which the first channel is a PUSCH and the first PDCCH schedules a plurality of TBs, a transmission end time of the PUSCH may be a third subframe in which the last retransmission of a PUSCH of the last TB in the plurality of TBs is located, or a transmission end time of the PUSCH may be a subframe next to a third subframe. The third subframe may be the last subframe in which the last retransmission of the PUSCH of the last TB in the plurality of TBs is located.

In some other embodiments, the first information may include the timing duration of the first HARQ RTT timer.

In some embodiments, the first timer may be started after the first HARQ RTT timer expires. For example, in a case that the first PDCCH schedules a single TB, the first timer may be started after the HARQ RTT timer corresponding to the first HARQ process expires. In a case that the first PDCCH schedules a plurality of TBs, the first timer may be started after HARQ RTT timers corresponding to all HARQ processes in the second mode in a plurality of HARQ processes used by the plurality of TBs expire.

A start time of the first HARQ RTT timer may be the transmission end time of the first channel. The transmission end time of the first channel may be described above, and details are not described herein again.

FIG. 7 is an example diagram of another method for starting a first timer according to an embodiment of this application. In the method shown in FIG. 7, the first timer may be started after the first HARQ RTT timer expires. As shown in FIG. 7, the transmission end time of the first channel is t1. At the moment t1, the first HARQ RTT timer may be started. The timing duration of the first HARQ RTT timer may be T. At a moment t2, the first HARQ RTT timer expires. At the moment t2, the first timer may be started.

It may be understood that the network device may also perform step S520, that is, the network device may determine the DRX behavior of the terminal device based on the mode corresponding to the first HARQ process. The network device may perform scheduling based on the DRX behavior of the terminal device.

The following describes in detail a method for determining the timing duration of the first HARQ RTT timer.

It should be noted that a unit of the timing duration of the first HARQ RTT timer may be a time domain unit. For example, the unit may be a subframe.

In some embodiments, the timing duration of the first HARQ RTT timer may be determined based on a predefined value. The predefined value may be defined in a protocol, or may be defined by the terminal device and/or the network device.

In some implementations, the timing duration of the first HARQ RTT timer may be a predefined value. For example, the predefined value may be 12 subframes, that is, the timing duration of the first HARQ RTT timer may be 12 subframes. In a case that the terminal device is an eMTC terminal device and/or an NB-IoT terminal device, it may be determined that the timing duration of the first HARQ RTT timer may be the predefined value.

In some other implementations, the timing duration of the first HARQ RTT timer may be determined based on a predefined value and a first interval (for example, which may be expressed as deltaPDCCH). The first interval may be, for example, a time interval between a first time domain unit and the 1^{st} time domain unit corresponding to a monitoring occasion of a next PDCCH. In a case that the terminal device is an NB-IoT terminal device, the timing duration of the first HARQ RTT timer may be determined based on the predefined value and the first interval.

The first time domain unit may be determined by using the transmission time of the first channel. For example, the first time domain unit may be the transmission end time of the first channel plus N time domain units; or the first time domain unit may be a time domain unit next to the transmission end time of the first channel plus N time domain units, where N may be an integer greater than 0. N may be predefined or preconfigured. For the transmission end time of the first channel, refer to the foregoing description. Details are not described herein again.

In an example in which the first PDCCH schedules a single downlink TB, the first interval may be, for example, a time interval between a subframe i and the 1^{st} subframe corresponding to a monitoring occasion of a next PDCCH. The subframe i may be a subframe next to a subframe in which the last retransmission of PDSCH reception is located+N subframes, or may be a subframe in which the last retransmission of PDSCH reception is located+N subframes.

In an example in which the first PDCCH schedules a plurality of downlink TBs, the first interval may be, for example, a time interval between a subframe i and the 1^{st} subframe corresponding to a monitoring occasion of a next PDCCH. The subframe i may be a subframe in which the last retransmission of PDSCH reception of the last TB in the plurality of TBs is located+N subframes, or a subframe next to a subframe in which the last retransmission of PDSCH reception of the last TB in the plurality of TBs is located+N subframes.

It may be understood that, that the timing duration of the first HARQ RTT timer is determined based on the predefined value described above may be applicable to any one of the following scenarios: the first PDCCH schedules a single downlink TB, the first PDCCH schedules a plurality of downlink TBs, the first PDCCH schedules a single uplink TB, and the first PDCCH schedules a plurality of uplink TBs. In a scenario in which the first PDCCH schedules a plurality of downlink TBs and at least one HARQ process in HARQ processes corresponding to the plurality of TBs is in the second mode, the first interval may also be referred to as a second interval.

In some embodiments, in a process of calculating the timing duration of the first HARQ RTT timer, an RTT offset of the first HARQ RTT timer may be 0. For example, in a case that the first TB is an uplink TB, if the first HARQ process is in the second mode, the RTT offset may be 0. In other words, if the serving cell of the terminal is an NTN cell, the timing duration of the first HARQ RTT timer may be the same as a definition or a value in an NT scenario. Alternatively, in a case that the first TB is a downlink TB, if the first HARQ process is in the second mode, the RTT offset may be 0 in an NTN scenario. It may be understood that, for a downlink TB, in a case that a mode of a HARQ process corresponding to the downlink TB is the first mode, the RTT offset may be a value specified in the related art (for example, which may be UE-eNB RTT) in the NTN scenario.

In a case that the first PDCCH schedules a plurality of TBs, the plurality of TBs correspond to a plurality of HARQ processes. The plurality of TBs may be downlink TBs. All the plurality of HARQ processes may be in the second mode, or a part of the plurality of HARQ processes may be in the second mode. It may be understood that the second mode may be a disable mode. In other words, all the plurality of HARQ processes may be in the disable mode, that is, HARQ feedback is not performed in all the plurality of HARQ processes, or a part of the plurality of HARQ processes may be in the disable mode, that is, a HARQ process in which HARQ feedback is performed may exist.

In a case that the first PDCCH schedules a plurality of TBs, the timing duration of the first HARQ RTT timer may be determined based on second information. The plurality of TBs correspond to a plurality of HARQ processes, and the second information includes one or more of the following: a quantity of HARQ processes in which HARQ feedback is performed in the plurality of HARQ processes; or HARQ feedback modes of the plurality of HARQ processes.

The HARQ feedback mode may further include a HARQ feedback mode in which HACK-ACK bundling is configured or a HARQ feedback mode in which HACK-ACK bundling is not configured.

In an embodiment, in a case that the quantity of HARQ processes in which HARQ feedback is performed in the plurality of HARQ processes is 0, the timing duration of the first HARQ RTT timer may be determined based on a predefined value. For example, the timing duration of the first HARQ RTT timer is determined based on the predefined value and a second interval. Optionally, the second interval is a time interval between a second time domain unit and the 1^{st} time domain unit corresponding to a monitoring occasion of a next PDCCH, and the second time domain unit may be determined based on the transmission time of the first channel. For descriptions of the second interval, refer to the related content of the first interval described above.

In an embodiment, in a case that the quantity of HARQ processes in which HARQ feedback is performed in the plurality of HARQ processes is greater than 0, the timing duration of the first HARQ RTT timer may be determined based on the HARQ feedback modes of the plurality of HARQ processes and the quantity of HARQ processes in which HARQ feedback is performed in the plurality of HARQ processes.

In some embodiments, if the first PDCCH schedules a plurality of downlink TBs at the same time and a HARQ feedback mode with HACK-ACK bundling is not configured, the timing duration of the first HARQ RTT timer may be 7+m*N+RTT offset, where N may be a PUCCH repetition factor, and m may be a quantity of TBs corresponding to downlink HARQ processes in which HARQ feedback is performed in a plurality of HARQ processes corresponding to the plurality of TBs indicated in the first PDCCH. This embodiment may be applied to an eMTC terminal device.

In some embodiments, if the first PDCCH schedules a plurality of downlink TBs at the same time and a HARQ feedback mode with HACK-ACK bundling is configured, the first HARQ RTT timer may be 7+k*N+RTT offset, where N may be a PUCCH repetition factor, and k may be a quantity of times of HARQ feedback bundling and may satisfy that k=ceiling (N_{TB}/M). N_{TB} may be a quantity of TBs corresponding to HARQ processes in which HARQ feedback is performed in a plurality of TBs indicated in the first PDCCH, and M may be a HARQ feedback bundling size of the plurality of TBs indicated in the first PDCCH, where ceiling ( ) represents rounding up, that is, rounding up in a direction in which an absolute value increases. For example, ceiling (4.1)=5 or ceiling (4.7)=5. This embodiment may be applied to an eMTC terminal device.

In some embodiments, in a case that the first PDCCH schedules a plurality of downlink TBs at the same time, if the plurality of TBs are non-interleaved or if the plurality of TBs are interleaved and a bundling HARQ feedback mode is not configured, and if HARQ feedback is not performed in a HARQ process corresponding to one TB (for example, the first TB) in the plurality of TBs, the timing duration of the HARQ RTT timer may be k+3+N+RTToffset+deltaPDCCH, where k may be a time interval between the last subframe for PDSCH transmission of the plurality of TBs and the 1^{st} subframe for transmission of a corresponding HARQ feedback, N may be transmission duration of the corresponding HARQ feedback, and deltaPDCCH may be a time interval between the start of a subframe next to the last subframe for transmission of the corresponding HARQ feedback+3+RTToffset and the 1^{st} subframe in which a monitoring occasion of a next PDCCH is located. This embodiment may be applied to an NB-IoT terminal.

It may be understood that, for a terminal configured with two HARQ processes, for example, an NB-IoT terminal, if one HARQ process in which HARQ feedback is performed and one HARQ process in which HARQ feedback is not performed exist in HARQ processes corresponding to a plurality of TBs scheduled by the first PDCCH, the definition of the first HARQ RTT timer may be the same as the case that the first PDCCH schedules a single downlink TB in the related art.

It should be noted that, in a case that the first PDCCH schedules a plurality of TBs including the first TB and a second HARQ process corresponding to a second TB in the plurality of TBs is in the first mode, a HARQ RTT timer corresponding to the second HARQ process is also calculated by using the method in the related art.

It may be understood that, in this application, based on the method for calculating timing duration of a HARQ RTT timer in the related art, a parameter related to a HARQ feedback is set as a preset value or is calculated through a HARQ process in which HARQ feedback is performed, so that impact of a HARQ process in the second mode on the timing duration of the HARQ RTT timer is properly configured, and the duration of the HARQ RTT timer can be more in line with an actual scenario.

It should be noted that the first HARQ RTT timer may be used not only to determine starting of the first timer, but also to implement another function. This is not limited in this application. In other words, the foregoing method for determining timing duration of a HARQ RTT timer may also be applied to another scenario related to the HARQ RTT timer. For example, based on the timing duration of the first HARQ RTT timer, a start time of a DRX on duration timer may be determined.

The following describes in detail the technical solutions provided in this application in five specific embodiments.

### Embodiment 1

Embodiment 1 relates to a case that a first PDCCH schedules a single downlink TB (a first TB). A second mode is a HARQ disable mode, that is, HARQ feedback is not performed in a first HARQ process corresponding to the first TB. The method provided in Embodiment 1 may include steps S610 to S620.

Step S610: A terminal device in a radio resource control (RRC) connected state receives a first PDCCH indicating to schedule PDSCH transmission of one TB.

Step S620: Determine DRX behavior of the terminal device based on a mode of a first HARQ process used for PDSCH transmission of a first TB.

In a case that the mode of the first HARQ process is the second mode, the DRX behavior may include step S621 or step S622.

Step S621: When completing PDSCH reception, the terminal may start a DRX deactivation timer and/or a DRX retransmission timer corresponding to the first HARQ process.

A moment at which the terminal device starts the DRX deactivation timer and/or the DRX retransmission timer corresponding to the first HARQ process may be a PDSCH transmission end time. The PDSCH transmission end time may be a subframe in which the last PDSCH retransmission is located, or a subframe next to a subframe in which the last PDSCH retransmission is completed.

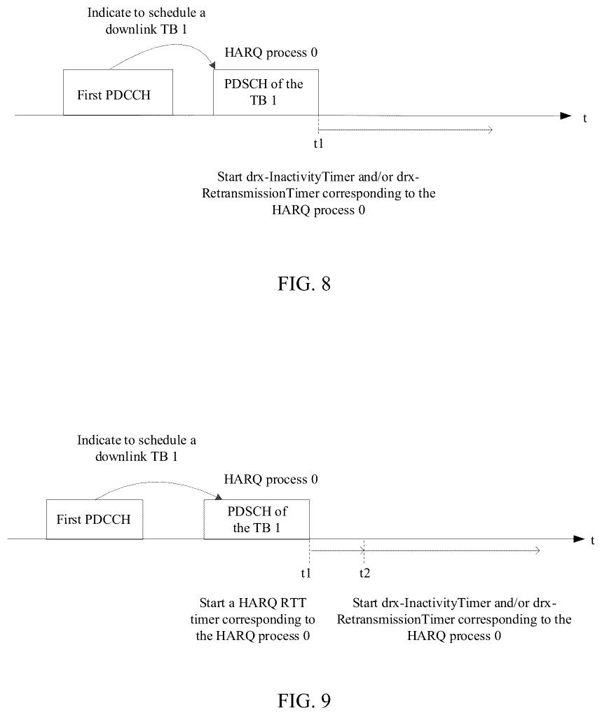

FIG. 8 is a schematic diagram of a communication method including step S621 according to an embodiment of this application. In FIG. 8, a TB 1 may be the first TB, and a HARQ process 0 may be the first HARQ process. At a PDSCH transmission end time t1, the terminal may start a DRX deactivation timer and/or a DRX retransmission timer corresponding to the HARQ process 0.

Step S622: The terminal starts a first HARQ RTT timer corresponding to the first HARQ process in the subframe in which the last PDSCH retransmission is located.

Timing duration of the first HARQ RTT timer may be a predefined value or a predefined value+deltaPDCCH.

For example, in a case that the terminal device is an eMTC terminal and/or an NB-IoT terminal device, the timing duration of the first HARQ RTT timer may be the predefined value; or in a case that the terminal device is an NB-IoT terminal device, the timing duration of the first HARQ RTT timer may be the predefined value+deltaPDCCH.

The predefined value may be, for example, 12 subframes.

deltaPDCCH may be a time interval between a subframe i and the 1^{st} subframe corresponding to a monitoring occasion of a next PDCCH. The subframe i may be a subframe next to a subframe in which the last retransmission of PDSCH reception is located+N subframes, or may be a subframe in which the last retransmission of PDSCH reception is located+N subframes, where N may be predefined.

FIG. 9 is a schematic diagram of a communication method including step S622 according to an embodiment of this application. In FIG. 9, a TB 1 may be the first TB, and a HARQ process 0 may be the first HARQ process. At a PDSCH transmission end time t1, the terminal device may start a first HARQ RTT timer corresponding to the HARQ process 0. At a moment t2 at which the first HARQ RTT timer expires, the terminal device may start a DRX deactivation timer and/or a DRX retransmission timer corresponding to the HARQ process 0.

### Embodiment 2

Embodiment 2 relates to a case that a first PDCCH schedules a single uplink TB (a first TB). A first HARQ process corresponding to the first TB is in a second mode. The method provided in Embodiment 2 may include steps S710 to S720.

Step S710: A terminal device in an RRC connected state receives a first PDCCH indicating to schedule PUSCH transmission of one TB.

Step S720: Determine DRX behavior of the terminal device based on a mode of a first HARQ process used for PUSCH transmission of a first TB.

In a case that the mode of the first HARQ process is the second mode, step S720 may include step S721 or step S722.

Step S721: After completing PUSCH transmission, the terminal device starts a DRX deactivation timer and/or a DRX uplink retransmission timer corresponding to the first HARQ process.

A moment of starting the DRX deactivation timer and/or the DRX uplink retransmission timer corresponding to the first HARQ process may be a PUSCH transmission end time. The PUSCH transmission end time may be the (last) subframe in which the last PUSCH retransmission (repetition) is located, or a subframe next to a subframe in which the last PUSCH retransmission is completed.

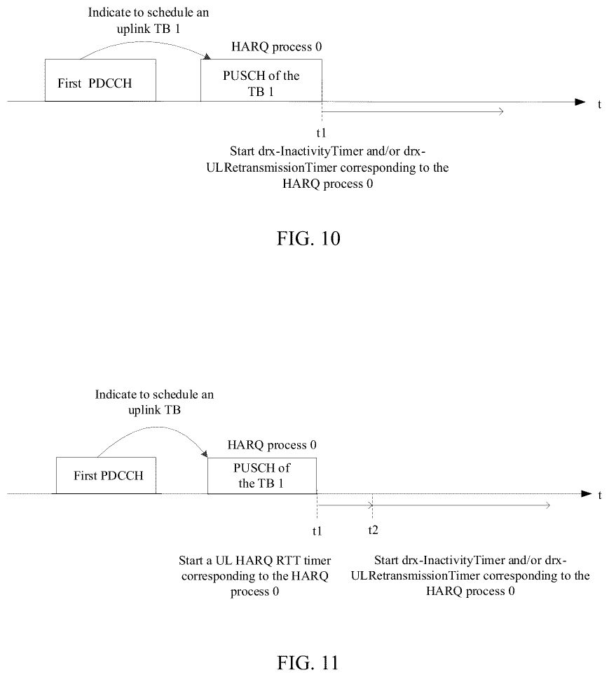

FIG. 10 is a schematic diagram of a communication method including step S721 according to an embodiment of this application. In FIG. 10, a TB 1 may be the first TB, and a HARQ process 0 may be the first HARQ process. At a PUSCH transmission end time t1, the terminal may start a DRX deactivation timer and/or a DRX uplink retransmission timer corresponding to the HARQ process 0.

Step S722: The terminal device starts a first HARQ RTT timer corresponding to the first HARQ process in the (last) subframe in which the last PUSCH retransmission is located.

The first HARQ RTT timer may be an uplink HARQ RTT timer. A definition of timing duration of the first HARQ RTT timer may be the same as a definition of timing duration of an uplink HARQ RTT timer in a TN scenario in the related art.

FIG. 11 is a schematic diagram of a communication method including step S722 according to an embodiment of this application. In FIG. 11, a TB 1 may be the first TB, and a HARQ process 0 may be the first HARQ process. At a PUSCH transmission end time t1, the terminal device may start a first HARQ RTT timer corresponding to the HARQ process 0. At a moment t2 at which the first HARQ RTT timer expires, the terminal device may start a DRX deactivation timer and/or a DRX uplink retransmission timer corresponding to the HARQ process 0.

### Embodiment 3

Embodiment 3 relates to a case that a first PDCCH schedules a plurality of downlink TBs at the same time. The plurality of downlink TBs include a first TB. A second mode is a HARQ disable mode, that is, HARQ feedback is not performed in a first HARQ process corresponding to the first TB. The method provided in Embodiment 3 may include steps S810 to S820.

Step S810: A terminal device in an RRC connected state receives a first PDCCH, where the first PDCCH indicates to schedule PDSCH transmission of a plurality of downlink TBs at the same time.

Step S810 may include step S811 or step S812.

Step S811: For an unbundling HARQ feedback manner, the terminal may sequentially send HARQ feedback to TBs whose used HARQ processes are in a first mode (an enable mode) in the plurality of downlink TBs that are scheduled at the same time.

Step S812: For a bundling HARQ feedback manner, for TBs whose used HARQ processes are in a first mode (an enable mode) in the plurality of downlink TBs that are scheduled at the same time, the terminal device sequentially binds HARQ feedback information of every M TBs to obtain one HARQ feedback result based on a HARQ feedback bundling size M. The terminal may sequentially send these bundling HARQ feedback results.

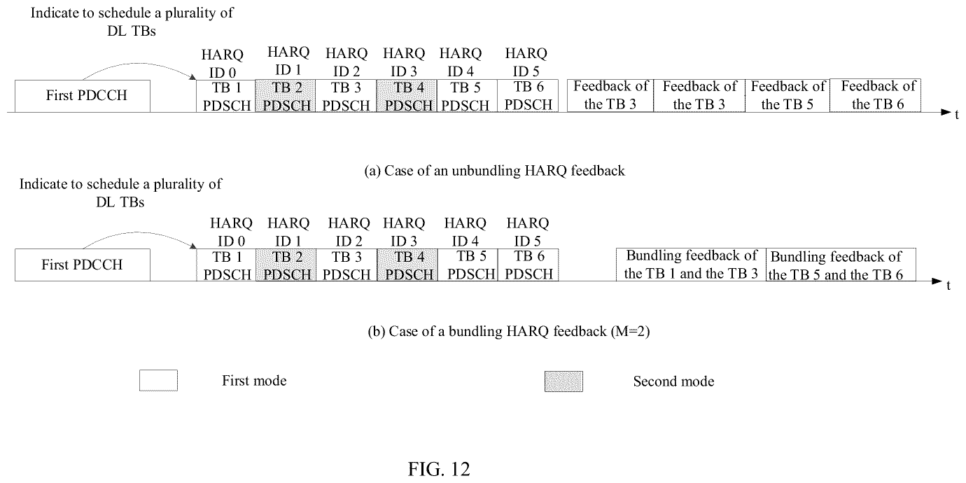

FIG. 12 is a schematic diagram of a feedback time sequence in which a first PDCCH schedules a plurality of downlink TBs according to an embodiment of this application. In FIG. 12, the first PDCCH may schedule the plurality of downlink TBs: a TB 1 to a TB 6. Modes of HARQ processes corresponding to the TB 2 and the TB 4 are the second mode, and modes of HARQ processes corresponding to the TB 1, the TB 3, the TB 5, and the TB 6 are the first mode. (a) in FIG. 12 illustrates an example of an unbundling HARQ feedback, that is, an example of step S811. In (a) in FIG. 12, the terminal sequentially sends HARQ feedback to the TB 1, the TB 3, the TB 5, and the TB 6. (b) in FIG. 12 illustrates an example of a bundling HARQ feedback, that is, an example of step S812. In (b) in FIG. 12, if the HARQ feedback bundling size M is 2, the terminal may bind HARQ feedback information of two TBs to obtain one feedback result. As shown in (b) in FIG. 12, HARQ feedback information of the TB 1 and the TB 3 is bound, and HARQ feedback information of the TB 5 and the TB 6 is bound.

Step S820: The terminal determines DRX behavior based on modes of the HARQ processes corresponding to the plurality of downlink TBs.

The DRX behavior may include one or more of the following behaviors: determining duration of a HARQ RTT timer, and starting of a DRX deactivation timer and/or a DRX retransmission timer.

The duration of the HARQ RTT timer may be determined based on a type of the terminal device and a HARQ feedback mode.

In an implementation, in a case that the type of the terminal device is eMTC, if the first PDCCH schedules a plurality of downlink TBs at the same time and a bundling HARQ feedback mode is not configured, timing duration of the HARQ RTT timer may be 7+m*N+RTT offset, where N may be a PUCCH repetition factor, and m may be a quantity of TBs whose used HARQ processes are in the first mode in the plurality of downlink TBs indicated in the first PDCCH.

In an implementation, in a case that the type of the terminal device is eMTC, if the first PDCCH schedules a plurality of downlink TBs at the same time and a bundling HARQ feedback mode is configured, the HARQ RTT timer may be 7+k*N+RTT offset, where N may be a PUCCH repetition factor, and k may be a quantity of times of HARQ feedback bundling and k may satisfy that k=ceiling (N_{TB}/M). N_{TB} may be a quantity of TBs whose used HARQ processes are in the first mode in the plurality of downlink TBs indicated in the first PDCCH, and M may be a HARQ feedback bundling size of the plurality of TBs indicated in the first PDCCH.

In an implementation, in a case that the type of the terminal device is NB-IoT, if the plurality of TBs are non-interleaved or if the plurality of downlink TBs are interleaved and a bundling HARQ feedback mode is not configured, and if a HARQ process used by one TB in the plurality of downlink TBs is in the second mode, the HARQ RTT timer may be k+3+N+RTToffset+deltaPDCCH, where k may be a time interval between the last subframe for PDSCH transmission of the plurality of downlink TBs and the 1^{st} subframe for transmission of a corresponding HARQ feedback, N may be transmission duration of the corresponding HARQ feedback, and deltaPDCCH may be a time interval between a subframe next to the last subframe for transmission of the corresponding HARQ feedback+3+RTToffset and the 1^{st} subframe in which a monitoring occasion of a next PDCCH is located. It may be understood that, in this case, a definition of the HARQ RTT timer may be the same as that in the case that a PDCCH schedules a single downlink TB.

### Embodiment 4

Embodiment 4 relates to a case that a first PDCCH schedules a plurality of downlink TBs at the same time. The plurality of downlink TBs include a first TB. A second mode is a HARQ disable mode, that is, HARQ feedback is not performed in a first HARQ process corresponding to the first TB. The method provided in Embodiment 4 may include steps S910 to S920.

Step S910: A terminal device in an RRC connected state receives a first PDCCH indicating to schedule PDSCH transmission of a plurality of downlink TBs at the same time.

Step S920: The terminal determines DRX behavior based on modes of HARQ processes corresponding to the plurality of downlink TBs.

In an implementation, if the HARQ processes used by the plurality of downlink TBs are in the second mode, step S920 may include step S921 or step S922.

Step S921: After completing PDSCH reception of the plurality of TBs, the terminal device starts a DRX deactivation timer and/or DRX retransmission timers corresponding to the HARQ processes used by the plurality of downlink TBs.

A moment at which the terminal device starts the DRX deactivation timer and/or the DRX retransmission timers corresponding to the HARQ processes used by the plurality of downlink TBs may be a subframe in which the last retransmission (repetition) of a PDSCH of the last TB in the plurality of downlink TBs is located, or a subframe next to a subframe in which the last retransmission of a PDSCH of the last TB in the plurality of downlink TBs is completed.

Step S922: The terminal device starts a HARQ RTT timer corresponding to the HARQ process in a subframe in which the last retransmission of a PDSCH of the last TB in the plurality of downlink TBs is located. Timing duration of the HARQ RTT timer may be determined based on a predefined value.

The timing duration of the HARQ RTT timer may be the predefined value or the predefined value+deltaPDCCH.

For example, in a case that the terminal device is an eMTC terminal and/or an NB-IoT terminal device, timing duration of a first HARQ RTT timer may be the predefined value; or in a case that the terminal device is an NB-IoT terminal device, timing duration of a first HARQ RTT timer may be the predefined value+deltaPDCCH.

The predefined value may be, for example, 12 subframes.

deltaPDCCH is a time interval between a subframe i and the 1^{st} subframe corresponding to a monitoring occasion of a next PDCCH. The subframe i may be a subframe next to a subframe in which the last retransmission of PDSCH reception is located+N subframes, or may be a subframe in which the last retransmission of PDSCH reception is located+N subframes, where N may be predefined.

In another implementation, HARQ processes used by a part of the plurality of TBs are in the second mode, and HARQ processes used by a part of the plurality of TBs are in the first mode.

For a HARQ process in the first mode in the HARQ processes used by the plurality of downlink TBs, the terminal may start a HARQ RTT timer corresponding to the HARQ process in a subframe in which the last retransmission of a PDSCH of the last TB in the plurality of downlink TBs is located. Duration of the HARQ RTT timer may be defined by using the method provided in Embodiment 3, and an RTT offset may be UE-eNB RTT. After HARQ RTT timers corresponding to these HARQ processes in the first mode expire, the terminal may start a DRX deactivation timer and/or DRX retransmission timers corresponding to these HARQ processes.

For a HARQ process in the second mode in the HARQ processes used by the plurality of downlink TBs, the terminal device may start a DRX deactivation timer and/or a DRX retransmission timer corresponding to the HARQ process after completing PDSCH reception of the plurality of downlink TBs. A moment at which the terminal device starts the DRX deactivation timer and/or the DRX retransmission timers corresponding to the HARQ processes used by the plurality of downlink TBs may be a subframe in which the last retransmission (repetition) of a PDSCH of the last TB in the plurality of downlink TBs is located, or a subframe next to a subframe in which the last retransmission of a PDSCH of the last TB in the plurality of downlink TBs is completed.

For a HARQ process in the second mode in the HARQ processes used by the plurality of downlink TBs, the terminal may start a HARQ RTT timer corresponding to the HARQ process in a subframe in which the last retransmission of a PDSCH of the last TB in the plurality of downlink TBs is located. Timing duration of the HARQ RTT timer may be a predefined value or a predefined value+deltaPDCCH; or the HARQ RTT timer may be determined based on the method provided in Embodiment 3, where an RTT offset may be 0.

After HARQ RTT timers corresponding to these HARQ processes in the second mode expire, the terminal may start a DRX deactivation timer and/or DRX retransmission timers corresponding to these HARQ processes.

### Embodiment 5

Embodiment 5 relates to a case that a first PDCCH schedules a plurality of uplink TBs at the same time. The plurality of uplink TBs may include a first TB. A first HARQ process corresponding to the first TB is in a second mode. The method provided in Embodiment 5 may include steps S1010 to S1020.

Step S1010: A terminal in an RRC connected state receives a PDCCH indicating to schedule PUSCH transmission of a plurality of uplink TBs at the same time.

Step S1020: If a HARQ process used by at least one TB in the plurality of uplink TBs is in a second mode, determine DRX behavior of the terminal device.

Step S1020 may include step S1021 or step S1022.

Step S1021: After completing PUSCH transmission of the plurality of uplink TBs, the terminal device starts a DRX deactivation timer and/or a DRX uplink retransmission timer corresponding to the HARQ process.

A moment at which the terminal device starts the DRX deactivation timer and/or the DRX uplink retransmission timer corresponding to the HARQ process may be a subframe (for example, the last subframe) in which the last retransmission of a PUSCH of the last TB in the plurality of uplink TBs is located, or a subframe next to a subframe in which the last retransmission of a PUSCH of the last TB in the plurality of uplink TBs is completed.

Step S1022: The terminal device starts an uplink HARQ RTT timer corresponding to the HARQ process in a subframe (for example, the last subframe) in which the last retransmission of a PUSCH of the last TB in the plurality of uplink TBs is located.

A definition of timing duration of the uplink HARQ RTT timer may be the same as a definition of timing duration of an uplink HARQ RTT timer in a TN scenario in the related art.

After HARQ RTT timers corresponding to these HARQ processes in the second mode expire, the terminal may start a DRX deactivation timer and/or DRX uplink retransmission timer corresponding to these HARQ processes.

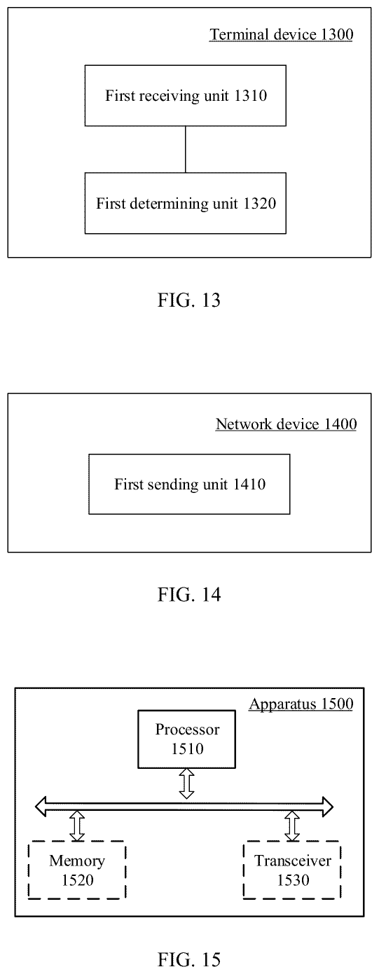

The foregoing describes method embodiments of this application in detail with reference to FIG. 1 to FIG. 12. The following describes apparatus embodiments of this application in detail with reference to FIG. 13 to FIG. 15. It should be understood that the descriptions of the apparatus embodiments correspond to the descriptions of the method embodiments, and therefore, for parts that are not described in detail, reference may be made to the foregoing method embodiments.

FIG. 13 is a schematic structural diagram of a terminal device 1300 according to an embodiment of this application. The terminal device 1300 may include a first receiving unit 1310 and a first determining unit 1320.

The first receiving unit 1310 may be configured to receive a first PDCCH, where the first PDCCH is used to schedule a first TB, and the first TB corresponds to a first HARQ process.

The first determining unit 1320 may be configured to determine DRX behavior of the terminal device based on a mode corresponding to the first HARQ process, where the mode corresponding to the first HARQ process includes a first mode and a second mode, and the first mode corresponds to DRX behavior different from the second mode.

Optionally, the DRX behavior includes a start time of a first timer, and the first timer includes a DRX deactivation timer and/or a DRX retransmission timer.

Optionally, if the first HARQ process is in the second mode, the start time of the first timer is determined based on first information, and the first information includes one or more of the following: a transmission time of a first channel, where the first channel carries the first TB; or timing duration of a first HARQ RTT timer, where the first HARQ RTT timer corresponds to the first HARQ process.

Optionally, the first information includes the transmission time of the first channel, and the first timer is started based on a transmission end time of the first channel.

Optionally, the transmission end time of the first channel is the last time domain unit in a time domain resource occupied by the first channel or a time domain unit next to the last time domain unit in a time domain resource occupied by the first channel.

Optionally, in a case that retransmission is performed on the first channel, the transmission end time of the first channel is a transmission end time of the last retransmission of the first channel.

Optionally, in a case that the first PDCCH schedules a plurality of TBs, the transmission end time of the first channel is a transmission end time of the last TB in the plurality of TBs.

Optionally, the first information includes the timing duration of the first HARQ RTT timer, and the first timer is started after the first HARQ RTT timer expires.

Optionally, the timing duration of the first HARQ RTT timer is determined based on a predefined value.

Optionally, the timing duration of the first HARQ RTT timer is determined based on the predefined value and a first interval.

Optionally, the first interval is a time interval between a first time domain unit and the 1^{st} time domain unit corresponding to a monitoring occasion of a next PDCCH, and the first time domain unit is determined based on the transmission time of the first channel.

Optionally, in a case that the first TB is an uplink TB, an RTT offset of the first HARQ RTT timer is 0.

Optionally, in a case that the first PDCCH schedules a plurality of TBs and all the plurality of TBs are downlink TBs, the timing duration of the first HARQ RTT timer is determined based on second information, where the plurality of TBs correspond to a plurality of HARQ processes, and the second information includes one or more of the following: a quantity of HARQ processes in which HARQ feedback is performed in the plurality of HARQ processes; or HARQ feedback modes of the plurality of HARQ processes.

Optionally, in a case that the quantity of HARQ processes in which HARQ feedback is performed in the plurality of HARQ processes is 0, the timing duration of the first HARQ RTT timer is determined based on a predefined value.

Optionally, the timing duration of the first HARQ RTT timer is determined based on the predefined value and a second interval.

Optionally, the second interval is a time interval between a second time domain unit and the 1^{st} time domain unit corresponding to a monitoring occasion of a next PDCCH, and the second time domain unit is determined based on the transmission time of the first channel.

Optionally, in a case that the quantity of HARQ processes in which HARQ feedback is performed in the plurality of HARQ processes is greater than 0, the timing duration of the first HARQ RTT timer is determined based on the HARQ feedback modes of the plurality of HARQ processes and the quantity of HARQ processes in which HARQ feedback is performed in the plurality of HARQ processes.

Optionally, the first channel is a PDSCH or a PUSCH.

Optionally, the time domain unit is any one of the following: a subframe, a slot, or one or more symbols.

Optionally, a serving cell of the terminal device is an NTN cell.

Optionally, the terminal device is an NB-IoT terminal device and/or an eMTC terminal device.

FIG. 14 is a schematic structural diagram of a network device 1400 according to an embodiment of this application. The network device 1400 may include a first sending unit 1410.

The first sending unit 1410 may be configured to send a first PDCCH, where the first PDCCH is used to schedule a first TB, and the first TB corresponds to a first HARQ process, where a mode corresponding to the first HARQ process is used to determine DRX behavior of a terminal device, the mode corresponding to the first HARQ process includes a first mode and a second mode, and the first mode corresponds to DRX behavior different from the second mode.

Optionally, the DRX behavior includes a start time of a first timer, and the first timer includes a DRX deactivation timer and/or a DRX retransmission timer.

Optionally, if the first HARQ process is in the second mode, the start time of the first timer is determined based on first information, and the first information includes one or more of the following: a transmission time of a first channel, where the first channel carries the first TB;

or timing duration of a first HARQ RTT timer, where the first HARQ RTT timer corresponds to the first HARQ process.

Optionally, the first information includes the transmission time of the first channel, and the first timer is started based on a transmission end time of the first channel.

Optionally, the transmission end time of the first channel is the last time domain unit in a time domain resource occupied by the first channel or a time domain unit next to the last time domain unit in a time domain resource occupied by the first channel.

Optionally, in a case that retransmission is performed on the first channel, the transmission end time of the first channel is a transmission end time of the last retransmission of the first channel.

Optionally, in a case that the first PDCCH schedules a plurality of TBs, the transmission end time of the first channel is a transmission end time of the last TB in the plurality of TBs.

Optionally, the first information includes the timing duration of the first HARQ RTT timer, and the first timer is started after the first HARQ RTT timer expires.

Optionally, the timing duration of the first HARQ RTT timer is determined based on a predefined value.

Optionally, the timing duration of the first HARQ RTT timer is determined based on the predefined value and a first interval.

Optionally, the first interval is a time interval between a first time domain unit and the 1^{st} time domain unit corresponding to a monitoring occasion of a next PDCCH, and the first time domain unit is determined based on the transmission time of the first channel.

Optionally, in a case that the first TB is an uplink TB, an RTT offset of the first HARQ RTT timer is 0.

Optionally, in a case that the first PDCCH schedules a plurality of TBs and all the plurality of TBs are downlink TBs, the timing duration of the first HARQ RTT timer is determined based on second information, where the plurality of TBs correspond to a plurality of HARQ processes, and the second information includes one or more of the following: a quantity of HARQ processes in which HARQ feedback is performed in the plurality of HARQ processes; or HARQ feedback modes of the plurality of HARQ processes.

Optionally, in a case that the quantity of HARQ processes in which HARQ feedback is performed in the plurality of HARQ processes is 0, the timing duration of the first HARQ RTT timer is determined based on a predefined value.

Optionally, the timing duration of the first HARQ RTT timer is determined based on the predefined value and a second interval.

Optionally, the second interval is a time interval between a second time domain unit and the 1^{st} time domain unit corresponding to a monitoring occasion of a next PDCCH, and the second time domain unit is determined based on the transmission time of the first channel.

Optionally, in a case that the quantity of HARQ processes in which HARQ feedback is performed in the plurality of HARQ processes is greater than 0, the timing duration of the first HARQ RTT timer is determined based on the HARQ feedback modes of the plurality of HARQ processes and the quantity of HARQ processes in which HARQ feedback is performed in the plurality of HARQ processes.

Optionally, the first channel is a PDSCH or a PUSCH.

Optionally, the time domain unit is any one of the following: a subframe, a slot, or one or more symbols.

Optionally, a serving cell of the terminal device is an NTN cell.

Optionally, the terminal device is an NB-IoT terminal device and/or an eMTC terminal device.

FIG. 15 is a schematic structural diagram of an apparatus according to an embodiment of this application. Dashed lines in FIG. 15 indicate that the unit or module is optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may allow the apparatus 1500 to implement the methods described in the foregoing method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program, and the program may be executed by the processor 1510 to cause the processor 1510 to execute the methods described in the foregoing method embodiments. The memory 1520 may be independent of the processor 1510 or may be integrated into the processor 1510.

The apparatus 1500 may further include a transceiver 1530. The processor 1510 may communicate with another device or chip through the transceiver 1530. For example, the processor 1510 may send and receive data to and from another device or chip through the transceiver 1530. An embodiment of this application further provides a computer-readable storage medium, configured to store a program. The computer-readable storage medium may be applied to the terminal or the network device provided in embodiments of this application, and the program causes a computer to execute the methods to be executed by the terminal or the network device in various embodiments of this application.

An embodiment of this application further provides a computer program product. The computer program product includes a program. The computer program product may be applied to the terminal or the network device provided in embodiments of this application, and the program causes a computer to execute the methods to be executed by the terminal or the network device in various embodiments of this application.

An embodiment of this application further provides a computer program. The computer program may be applied to the terminal or the network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to explain specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, the “indication” mentioned herein may be a direct indication or an indirect indication, or indicate an association relationship. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association relationship between A and B.

In embodiments of this application, “B corresponding to A” means that B is associated with A, and B may be determined based on A. However, it should also be understood that, determining B based on A does not mean determining B based only on A, but instead B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefining” or “preconfiguring” may be implemented in a manner in which corresponding code, a table, or other related information used for indication is prestored in a device (for example, including a terminal device and a network device), and a specific implementation is not limited in this application. For example, the “predefining” may refer to being defined in a protocol.

In embodiments of this application, the “protocol” may refer to a standard protocol in the communications field, for example, may include an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes shall be determined according to functions and internal logic of the processes, and shall not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual requirements to achieve the objective of the solutions of embodiments.

In addition, function units in embodiments of this application may be integrated into one processing unit, or each of the units may exist alone physically, or two or more units may be integrated into one unit.

All or some of the foregoing embodiments may be implemented by software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
receiving, by a terminal device, a first physical downlink control channel (PDCCH), wherein the first PDCCH is used to schedule a first transport block (TB), and the first TB corresponds to a first hybrid automatic repeat request (HARQ) process; and
determining, by the terminal device, discontinuous reception (DRX) behavior of the terminal device based on a mode corresponding to the first HARQ process, wherein the mode corresponding to the first HARQ process comprises a first mode and a second mode, and the first mode corresponds to DRX behavior different from the second mode.

2. The method according to claim 1, wherein the DRX behavior comprises a start time of a first timer, and the first timer comprises a DRX deactivation timer and/or a DRX retransmission timer, wherein if the first HARQ process is in the second mode, the start time of the first timer is determined based on first information, and the first information comprises one or more of the following:
a transmission time of a first channel, wherein the first channel carries the first TB; or
timing duration of a first HARQ round-trip time (RTT) timer, wherein the first HARQ RTT timer corresponds to the first HARQ process, wherein the first channel is a PDSCH or a PUSCH.

3. The method according to claim 2, wherein the first information comprises the transmission time of the first channel, and the first timer is started based on a transmission end time of the first channel, wherein the transmission end time of the first channel is the last time domain unit in a time domain resource occupied by the first channel or a time domain unit next to the last time domain unit in a time domain resource occupied by the first channel, wherein in a case that retransmission is performed on the first channel, the transmission end time of the first channel is a transmission end time of the last retransmission of the first channel, wherein in a case that the first PDCCH schedules a plurality of TBs, the transmission end time of the first channel is a transmission end time of the last TB in the plurality of TBs, wherein the time domain unit is any one of the following: a subframe, a slot, or one or more symbols.

4. The method according to claim 2, wherein the first information comprises the timing duration of the first HARQ RTT timer, and the first timer is started after the first HARQ RTT timer expires, wherein the timing duration of the first HARQ RTT timer is determined based on a predefined value, wherein the timing duration of the first HARQ RTT timer is determined based on the predefined value and a first interval, wherein the first interval is a time interval between a first time domain unit and the 1^{st} time domain unit corresponding to a monitoring occasion of a next PDCCH, and the first time domain unit is determined based on the transmission time of the first channel, wherein the time domain unit is any one of the following: a subframe, a slot, or one or more symbols.

5. An apparatus, wherein the apparatus is a terminal device and comprises a processor, configured to invoke a program from a memory, to cause the apparatus to execute:
receiving a first physical downlink control channel (PDCCH), wherein the first PDCCH is used to schedule a first transport block (TB), and the first TB corresponds to a first hybrid automatic repeat request (HARQ) process; and
determining discontinuous reception (DRX) behavior of the terminal device based on a mode corresponding to the first HARQ process, wherein the mode corresponding to the first HARQ process comprises a first mode and a second mode, and the first mode corresponds to DRX behavior different from the second mode.

6. The apparatus according to claim 5, wherein the DRX behavior comprises a start time of a first timer, and the first timer comprises a DRX deactivation timer and/or a DRX retransmission timer, wherein if the first HARQ process is in the second mode, the start time of the first timer is determined based on first information, and the first information comprises one or more of the following:
a transmission time of a first channel, wherein the first channel carries the first TB; or
timing duration of a first HARQ round-trip time (RTT) timer, wherein the first HARQ RTT timer corresponds to the first HARQ process, wherein the first channel is a PDSCH or a PUSCH.

7. The apparatus according to claim 6, wherein the first information comprises the transmission time of the first channel, and the first timer is started based on a transmission end time of the first channel, wherein the transmission end time of the first channel is the last time domain unit in a time domain resource occupied by the first channel or a time domain unit next to the last time domain unit in a time domain resource occupied by the first channel, wherein in a case that retransmission is performed on the first channel, the transmission end time of the first channel is a transmission end time of the last retransmission of the first channel, wherein in a case that the first PDCCH schedules a plurality of TBs, the transmission end time of the first channel is a transmission end time of the last TB in the plurality of TBs, wherein the time domain unit is any one of the following: a subframe, a slot, or one or more symbols.

8. The apparatus according to claim 6, wherein the first information comprises the timing duration of the first HARQ RTT timer, and the first timer is started after the first HARQ RTT timer expires, wherein the timing duration of the first HARQ RTT timer is determined based on a predefined value, wherein the timing duration of the first HARQ RTT timer is determined based on the predefined value and a first interval, wherein the first interval is a time interval between a first time domain unit and the 1^{st} time domain unit corresponding to a monitoring occasion of a next PDCCH, and the first time domain unit is determined based on the transmission time of the first channel, wherein the time domain unit is any one of the following: a subframe, a slot, or one or more symbols.

9. The apparatus according to claim 8, wherein in a case that the first PDCCH schedules a plurality of TBs and all the plurality of TBs are downlink TBs, the timing duration of the first HARQ RTT timer is determined based on second information, wherein the plurality of TBs correspond to a plurality of HARQ processes, and the second information comprises one or more of the following:
a quantity of HARQ processes in which HARQ feedback is performed in the plurality of HARQ processes; or
HARQ feedback modes of the plurality of HARQ processes.

10. The apparatus according to claim 9, wherein in a case that the quantity of HARQ processes in which HARQ feedback is performed in the plurality of HARQ processes is 0, the timing duration of the first HARQ RTT timer is determined based on a predefined value, wherein the timing duration of the first HARQ RTT timer is determined based on the predefined value and a second interval, wherein the second interval is a time interval between a second time domain unit and the 1^{st} time domain unit corresponding to a monitoring occasion of a next PDCCH, and the second time domain unit is determined based on the transmission time of the first channel, wherein the time domain unit is any one of the following: a subframe, a slot, or one or more symbols.

11. The apparatus according to claim 9, wherein in a case that the quantity of HARQ processes in which HARQ feedback is performed in the plurality of HARQ processes is greater than 0, the timing duration of the first HARQ RTT timer is determined based on the HARQ feedback modes of the plurality of HARQ processes and the quantity of HARQ processes in which HARQ feedback is performed in the plurality of HARQ processes.

12. The apparatus according to claim 5, wherein a serving cell of the terminal device is a non-terrestrial network (NTN) cell, wherein the terminal device is a narrowband internet of things (NB-IoT) terminal device and/or an enhanced machine type communication (eMTC) terminal device.

13. An apparatus, wherein the apparatus is a network device and comprises a processor, configured to invoke a program from a memory, to cause the apparatus to execute:
sending a first physical downlink control channel (PDCCH), wherein the first PDCCH is used to schedule a first transport block (TB), and the first TB corresponds to a first hybrid automatic repeat request (HARQ) process,
wherein a mode corresponding to the first HARQ process is used to determine discontinuous reception (DRX) behavior of a terminal device, the mode corresponding to the first HARQ process comprises a first mode and a second mode, and the first mode corresponds to DRX behavior different from the second mode.

14. The apparatus according to claim 13, wherein the DRX behavior comprises a start time of a first timer, and the first timer comprises a DRX deactivation timer and/or a DRX retransmission timer, wherein if the first HARQ process is in the second mode, the start time of the first timer is determined based on first information, and the first information comprises one or more of the following:
a transmission time of a first channel, wherein the first channel carries the first TB; or
timing duration of a first HARQ round-trip time (RTT) timer, wherein the first HARQ RTT timer corresponds to the first HARQ process, wherein the first channel is a PDSCH or a PUSCH.

15. The apparatus according to claim 14, wherein the first information comprises the transmission time of the first channel, and the first timer is started based on a transmission end time of the first channel, wherein the transmission end time of the first channel is the last time domain unit in a time domain resource occupied by the first channel or a time domain unit next to the last time domain unit in a time domain resource occupied by the first channel, wherein in a case that retransmission is performed on the first channel, the transmission end time of the first channel is a transmission end time of the last retransmission of the first channel, wherein in a case that the first PDCCH schedules a plurality of TBs, the transmission end time of the first channel is a transmission end time of the last TB in the plurality of TBs, wherein the time domain unit is any one of the following: a subframe, a slot, or one or more symbols.

16. The apparatus according to claim 14, wherein the first information comprises the timing duration of the first HARQ RTT timer, and the first timer is started after the first HARQ RTT timer expires, wherein the timing duration of the first HARQ RTT timer is determined based on a predefined value, wherein the timing duration of the first HARQ RTT timer is determined based on the predefined value and a first interval, wherein the first interval is a time interval between a first time domain unit and the 1^{st} time domain unit corresponding to a monitoring occasion of a next PDCCH, and the first time domain unit is determined based on the transmission time of the first channel, wherein the time domain unit is any one of the following: a subframe, a slot, or one or more symbols.

17. The apparatus according to claim 16, wherein in a case that the first PDCCH schedules a plurality of TBs and all the plurality of TBs are downlink TBs, the timing duration of the first HARQ RTT timer is determined based on second information, wherein the plurality of TBs correspond to a plurality of HARQ processes, and the second information comprises one or more of the following:
a quantity of HARQ processes in which HARQ feedback is performed in the plurality of HARQ processes; or
HARQ feedback modes of the plurality of HARQ processes.

18. The apparatus according to claim 17, wherein in a case that the quantity of HARQ processes in which HARQ feedback is performed in the plurality of HARQ processes is 0, the timing duration of the first HARQ RTT timer is determined based on a predefined value, wherein the timing duration of the first HARQ RTT timer is determined based on the predefined value and a second interval, wherein the second interval is a time interval between a second time domain unit and the 1^{st} time domain unit corresponding to a monitoring occasion of a next PDCCH, and the second time domain unit is determined based on the transmission time of the first channel, wherein the time domain unit is any one of the following: a subframe, a slot, or one or more symbols.

19. The apparatus according to claim 17, wherein in a case that the quantity of HARQ processes in which HARQ feedback is performed in the plurality of HARQ processes is greater than 0, the timing duration of the first HARQ RTT timer is determined based on the HARQ feedback modes of the plurality of HARQ processes and the quantity of HARQ processes in which HARQ feedback is performed in the plurality of HARQ processes.

20. The apparatus according to claim 13, wherein a serving cell of the terminal device is a non-terrestrial network (NTN) cell, wherein the terminal device is a narrowband internet of things (NB-IoT) terminal device and/or an enhanced machine type communication (eMTC) terminal device.
